(19) United States
(12) Patent Application Publication
(10) Pub. No.: US 2006/0121751 A1
(43) Pub. Date: Jun. 8, 2006

(54) LGA socket connector with floating cover

(75) Inventor: Fang-Jwu Liao, Tu-Cheng (TW)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 11/294,191

(22) Filed: Dec. 5, 2005

(30) Foreign Application Priority Data
Dec. 3, 2004 (TW) 93219493

(51) Int. Cl. H01R 12/00

(52) U.S. Cl. 439/66

(57) ABSTRACT

Disclosed is an electrical connector assembly including an insulative housing (10) with a plurality of passageways (103) therethrough from a top mating interface (100). A plurality of terminals (20) is inserted into the passageways with upper connecting portions (202) thereof have projections overlapped. A floating cover (30) is movably mounted above the base, and defines at least one slot (305) extending in a row direction along which, from a top view, the whole upper connecting portions direct to. The slot is configured to allow for upper mating sections (2021) of the whole row of terminals to be simultaneously extended therethrough when the floating cover is pressed downwardly to engage with the base. Thus, no damage will bring to the terminals that have overlapped configuration.

### BACKGROUND OF THE INVENTION

1. Field of the Invention

The present invention relates to an electrical socket connector, and more particularly to an LGA socket with floating cover member for protecting terminals from being damaged during transporting process.

2. Background of the Invention

The development of the connector industry toward the miniaturized, high-density and more reliable trends has required many connectors, especially LGA sockets, to be arranged in a high-density manner to keep up with the trends. The LGA socket is one of the most favorable and user-friendly products for electrical connection of a chip package and a printed circuit board. Effective electrical connection between the chip package and the printed circuit board is formed by continuous pressure against the package mounted on the LGA socket.

The LGA socket generally includes a base defining a receiving space for receiving the chip package therein. A plurality of terminals is assembled in the base, for electrically connecting with the chip package to be received in the base. The terminals are typically designed to have upper contacting portions extending out of a top surface of the base, for engaging with conductive elements, such as pads, of the chip package subsequently placed on the base. Since the terminals have portions thereof exposed outside of the base, the terminals may be readily damaged by improper external force, especially during transporting process. This will readily result in electrical connection failure between the chip package and the LGA socket.

Several protecting means have been developed to overcome this problem. One of the simplest means is provided with a floating cover member. The floating cover member forms a plurality of holes for accommodating the respective upper contacting portions of the terminals. That is, one hole of the floating cover corresponds to one upper contacting portion of the terminal. However, with the terminals to be required increasingly density and have better elasticity thereof, the terminals tend to have upper contacting portions partially overlapped both horizontally and vertically. As such, it is difficult for these overlapped terminals to be separated therefrom or accommodated with the holes one by one. In other words, such conventional floating cover member is not capable of effectively protecting the overlapped terminals from being damaged, especially during the transporting process.

### SUMMARY OF THE INVENTION

In order to resolve the existing issues encountered by the industry, the inventor provides the following solutions so as to overcome the shortcoming of the existing design. According to one of the preferred embodiments, an electrical connector assembly includes an insulative housing having a base with a top mating interface thereof. A plurality of passageways is arranged in rows and extends through the base from the top mating interface, with a plurality of terminals inserted into the corresponding passageways. The terminals have upper connecting portions with at distal ends thereof upper mating sections extending upwardly from the mating interface. The upper connecting portions of at least two adjacent terminals, in a same row, are configured to have projections, from a top view, at least partly overlapped. A floating cover is resiliently and movably mounted above the top mating interface of the base, and defines at least one slot therethrough extending in a row direction along which, from a top view, the whole upper connecting portions essentially direct to. The slot is further configured to allow for the upper mating sections of the at least two adjacent terminals to be simultaneously extend through the slot when the floating cover is pressed downwardly to engage with the base. Thus, no damage will bring to the at least two terminals that have overlapped configuration.

Other features and advantages of the present invention will become more apparent to those skilled in the art upon examination of the following drawings and detailed description of preferred embodiments, in which:

### BRIEF DESCRIPTION OF THE DRAWINGS

FIG. 1 is a simplified, exploded isometric view of an electrical connector assembly according to a preferred embodiment of the present invention;

FIG. 2 is another exploded isometric view of the electrical connector assembly of FIG. 1, but viewed from another aspect and not showing terminals and springs therein;

FIG. 3 is an assembled, isometric view of the electrical connector assembly of FIG. 1;

FIG. 4 is an enlarged, plan view of a circle portion IV of the electrical connector assembly of FIG. 3;

FIG. 5 is a cross-section view of the electrical connector assembly of FIG. 3 taken on the line of A-A, showing the electrical connector assembly at a first uncompressed position; and

FIG. 6 is a cross-section view of the electrical connector assembly of FIG. 3 taken on the line of A-A, but showing the electrical connector assembly in a second compressed position.

### DETAILED DESCRIPTION OF PREFERRED EMBODIMENTS

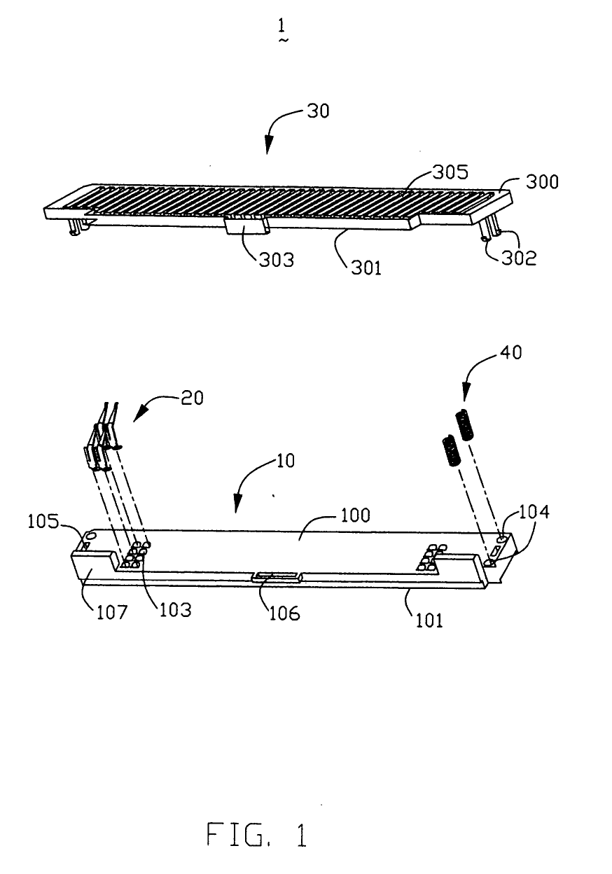

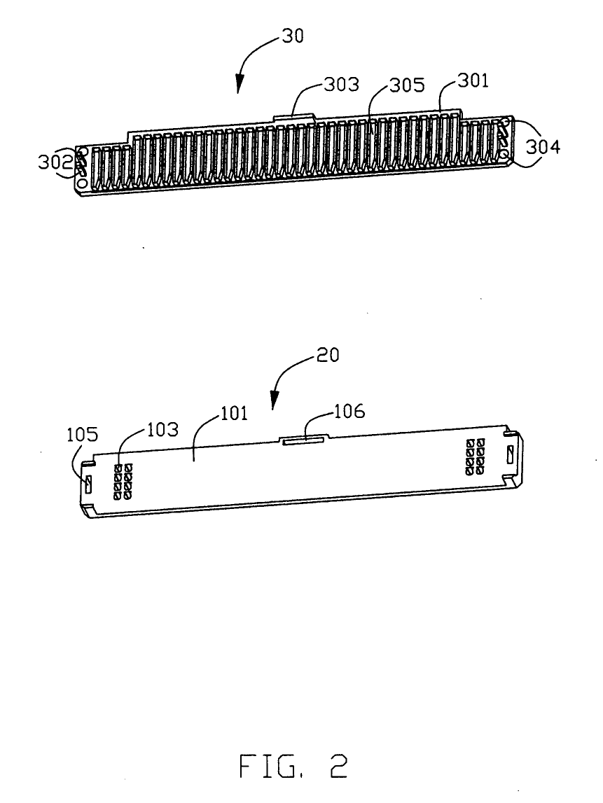

Referring to FIGS. 1 to 6, an LGA socket connector 1 according to the preferred embodiment includes an insulative housing 10 having a plurality of terminals 20 assembled therein, a floating cover member 30 movably mounted above the base 10, and a plurality of compressing springs 40 supported between the housing 10 and the floating cover member 30.

The insulative housing 10 is generally of a rectangular shape, and has a base defining a top mating interface 100 adapted to face the floating cover member 30, and a mounting interface 101, which is adapted to face a printed circuit board (not shown). A plurality of passageways 103 is arranged in columns and rows and extends through the housing base 10 from the mating interface 100 toward the mounting interface 101. Around the passageways 103, the base 10 is provided with two pairs of blind holes 104 respectively at opposite ends thereof. The blind hole 104 has a predetermined height thereof extending from the mating interface and is adapted for one of the ends of the spring 40 to be accommodated therein. A positioning slot 105 forms between each pair of the blind holes 104, for engaging with catches 302 of the floating cover 30, to be later described. Additionally, the base 10 is formed with blocking walls 107 along one lengthwise end of the base and a retention slot 106 between the blocking walls 107, for engagement with the corresponding portions, such as a protrusion 303 of the floating cover 30.

Each of the terminals 20 is assembled into the corresponding passageway 103, and includes a main portion 201 retained in the passageway 103, upper and lower connecting portions 202, 203 extending upwardly and downwardly from the passageway 103 respectively. At a distal end of the connecting upper portion 202 is provided with a mating section 2021. The mating section 2021 has a predetermined height from the top mating interface 100 so as to engage with the chip package (not shown) to be placed on the base 10. As shown in FIG. 1, the terminals 20 including the upper connecting portions 202 thereof, in a same row and/or in different rows, are substantially parallel to each other. Further, the upper connecting portions 202 of at least two adjacent terminals 20 in a same row have projections thereof, from a top view, at least partly overlapped. In the preferred embodiment as shown in FIG. 4, projections of the upper connecting portions 202 of two every adjacent terminals 20, from a top view, are overlapped in sequence.

The floating cover member 30 is resiliently and movably mounted above the base with compressing springs 40 supported thereby. The floating cover member 30 has a shape similar to that of the housing base 10, and defines a mating surface 300, adapted to mate with the chip package, and a mounting surface 301, which is adapted to engage with the base 10. Two pairs of latches 302, for engaging with the positioning slots 105, are formed at opposite ends of the floating cover member 30 respectively and extend from the mounting surface 301 toward the mating interface 100 of the base 10. The floating cover member 30 is provided with the protrusion 303, for engaging with the retention slot 106 formed on the base 10. A pair of receiving holes 304 forms at opposite sides of each of the positioning slots 105, for corresponding to the blind holes 104. The receiving hole 304 has a predetermined height thereof extending from the mounting surface 301 toward the mating surface 300, and is adapted for the other end of the spring 40 to be accommodated therein.

The floating cover member 30 is provided with a plurality of parallel slots 305 extending through the floating cover 30 from the mating surface 300 toward the mounting surface 301. As shown in FIG. 4, the slots 305 are arranged in correspondence with the rows of the terminals 20, and extend in a row direction along which, from a top view, the whole upper connecting portions 202 essentially direct to. Each of the slots 305 is configured to allow for the upper mating sections 2021 of the at least two adjacent terminals 20, in the same row, to be accommodated within the slot 305 when the floating cover 30 is mounted above the top mating interface 100 during transporting process, and allow for the upper mating sections 2021 of the at least two adjacent terminals 20 to be simultaneously extend through the slot 305 when the floating cover 30 is pressed downwardly to engage with the base 10. In the present embodiment, each slot 305 is preferably configured for receiving the corresponding row of terminals 20 therein. Thus, no damage will bring to the whole row of terminals that have overlapped configuration.

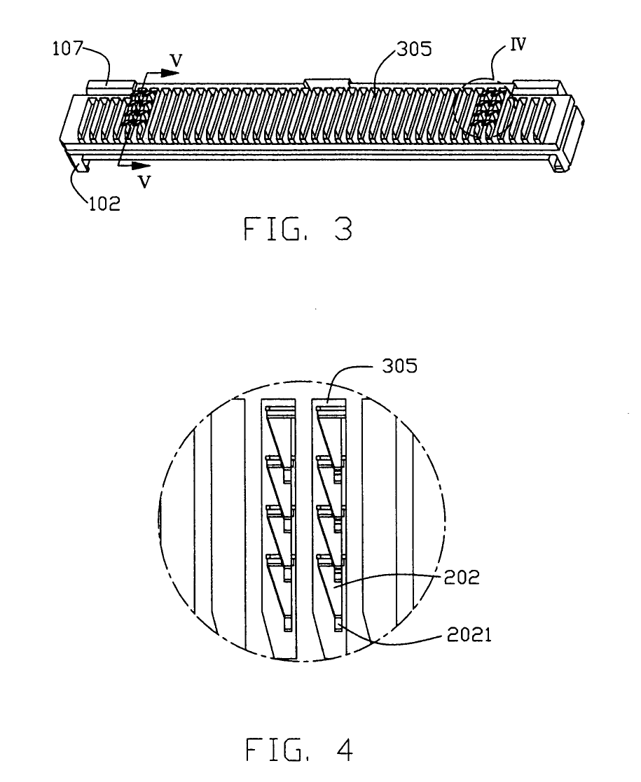

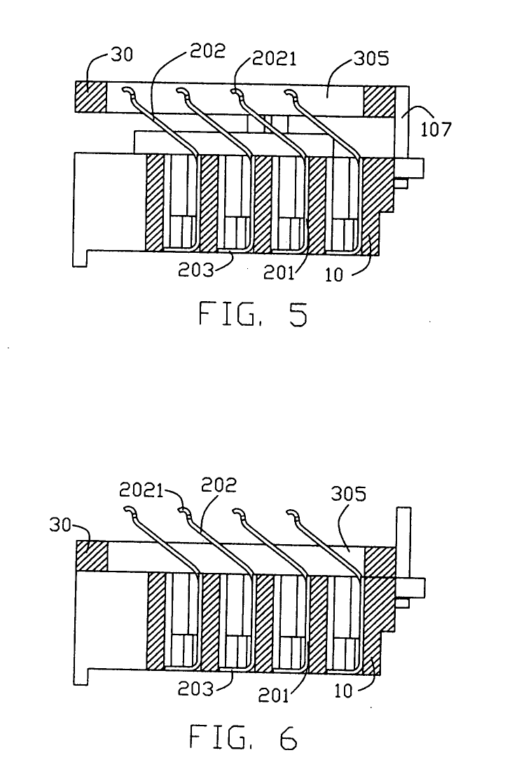

Referring to FIGS. 3 to 6, in assembly of the LGA socket, the terminals 20 are inserted into the corresponding terminal receiving passageways 103. The compressing springs 40 are loaded into the blind holes 104 with first ends thereof engaging against the bottom surface of the blind holes 104. The floating cover member 30 is then assembled to the base 10 by the latches 302 engaging into the positioning slot 105, and second opposite ends of the compressing springs 40 engaging into the receiving holes 304 for support of the floating cover member 30. At this position, the base 10 and the floating cover member 30 are held in spaced relation to each other by the springs 40 supported therebetween, and the whole row of the overlapped terminals 20 have upper mating sections 2021 thereof accommodated within the corresponding slot 305 so as not to be exposed outside of the mating surface 300 of the floating cover 30, as shown in FIG. 5. Thus, no damage will bring to the whole row of terminals 20 that have overlapped configuration, and the terminals 20 particularly including the upper mating sections 2021 thereof are prevented from being damaged by external force during the transporting process, thereby achieving effective electrical connection between the chip package and the LGA socket.

Referring particularly to FIG. 6, in use of the LGA socket, the chip package (not shown) is placed onto the mating surface 300 of the base 30. By an external force exerted on the chip package, the springs 40 are compressed and the floating cover 30 is forced downwardly and toward the base 10 to engage with the base 10 by the mounting surface 301 in contact with the mating interface 100. At the same time, the terminals 20 along the same row is forced downwardly and toward the mating surface 300 of the base 30 so as to allow for the upper mating sections 2021 of the terminals 20 to be simultaneously extend through the corresponding slot 305 when the floating cover 30 is pressed downwardly to engage with the base 10. Thus, no damage will bring to the whole row of terminals 20 that have overlapped configuration.

While the present invention has been described with reference to preferred embodiments, the description of the invention is illustrative and is not to be construed as limiting the invention. Various of modifications to the present invention can be made to preferred embodiments by those skilled in the art without departing from the true spirit and scope of the invention as defined by the appended claims.

1. An electrical connector assembly comprising:
an insulative housing having a base defining a top mating interface thereof, with a plurality of passageways arranged in rows and extending through the base from the top mating interface;
a plurality of terminals disposed in the passageways respectively, the terminals having upper connecting portions with at distal ends thereof upper mating sections extending upwardly from the top mating interface;
the upper connecting portions of at least two adjacent terminals in a same row having projections, from a top view, at least partly overlapped;
a floating cover resiliently and movably mounted above the top mating interface of the base, the floating cover defining at least one slot therethrough and extending essentially in a row direction along which, from a top view, the whole upper connecting portions essentially direct to, said slot configured to allow for the upper mating sections of the at least two adjacent terminals to be simultaneously extended therethrough when the floating cover is pressed downwardly to engage with the base.

2. The electrical connector assembly as recited in claim 1, wherein the upper connecting portions of two every adjacent terminals in a same row have projections, from a top view, partly overlapped in sequence.

3. The electrical connector assembly as recited in claim 1, wherein said slot is configured for receiving the corresponding row of terminals.

4. The electrical connector assembly as recited in claim 3, wherein the floating cover comprises a plurality of parallel slots in correspondence with the rows of the terminals.

5. The electrical connector assembly as recited in claim 1, further comprising at least one spring supported between the base and the floating cover.

6. The electrical connector assembly as recited in claim 1, the base comprises a plurality of positioning holes, and the floating cover comprises a plurality of catches for engaging into the corresponding positioning holes of the base.

7. An electrical connector comprising:
an insulative housing having a base defining a top mating interface thereof, with a plurality of passageways arranged in rows and extending through the base from the top mating interface;
a plurality of terminals disposed in the passageways, the terminals having upper connecting portions with at distal ends thereof upper mating sections essentially extending upwardly from the top mating interface;
the upper connecting portions of at least two adjacent terminals in a same row having projections thereof, from a top view, at least partly overlapped;
a floating cover movably mounted above the top mating interface of the base, the floating cover defining at least one slot therethrough and extending in a row direction along which, from a top view, the whole upper connecting portions essentially direct to, said slot configured to allow for the upper mating sections of the two adjacent terminals to be accommodated within said slot when the floating cover is mounted above the top mating interface.

8. The electrical connector as recited in claim 7, wherein the upper connecting portions of two every adjacent terminals in a same row have projections, from a top view, partly overlapped in sequence.

9. The electrical connector as recited in claim 7, wherein said slot is configured for receiving the corresponding row of terminals.

10. The electrical connector as recited in claim 9, wherein the floating cover comprises a plurality of parallel slots in correspondence with the rows of the terminals.

11. The electrical connector as recited in claim 7, further comprising at least one spring supported between the base and the floating cover.

12. The electrical connector as recited in claim 7, the base comprises a plurality of positioning holes, and the floating cover comprises a plurality of catches for engaging into the corresponding positioning holes of the base.

13. An electrical connector comprising:
an insulative housing having a base defining a top mating interface thereof,
a plurality of terminals disposed in the housing and having upper connecting portions with at distal ends thereof upper mating sections essentially extending upwardly from the top mating interface;
the upper connecting portions of at least two adjacent terminals in a same row having projections thereof, from a top view, at least partly overlapped;
a floating cover mounted above the top mating interface of the base and being movable up and down, the floating cover defining at least one slot therethrough and extending in a row direction along which, from a top view, the whole upper connecting portions essentially direct to, said slot configured to allow the upper mating section of the terminal to move relative to the floating cover not only in a vertical direction but also in the row direction.
